(19) United States
(12) Patent Application Publication
(10) Pub. No.: US 2026/0054686 A1
(43) Pub. Date: Feb. 26, 2026

(54) VEHICLE SEAT BELT COUPLING APPARATUS

(71) Applicant: WOOSHIN SAFETY SYSTEMS CO.,LTD., Gyeonggi-do (KR)

(72) Inventor: Chang Hee YE, Gyeonggi-do (KR)

(21) Appl. No.: 19/294,754

(22) Filed: Aug. 8, 2025

(30) Foreign Application Priority Data
Aug. 26, 2024 (KR) 10-2024-0113980

(51) Int. Cl. B60R 22/18

(52) U.S. Cl. CPC B60R 22/18; B60R 2022/1806

(57) ABSTRACT

The present invention relates to a vehicle seat belt coupling apparatus for quickly and easily installing a seat belt into a vehicle, comprising a first tongue plate provided at an end of a webbing, a fixing bracket fixed to said first tongue plate, a low anchor having a second tongue plate fitted to the fixing bracket and fixed to the body of a vehicle at one lower side of the seat, and a locking element installed inside said fixing bracket for locking or unlocking the second tongue plate fitted to the fixing bracket.

### CROSS-REFERENCE TO RELATED APPLICATION

The present application claims priority under 35 U.S. C. § 119(a) to Korean Patent Application No. 10-2024-0113980, filed in the Korean Intellectual Property Office on Aug. 26, 2024, the entire disclosure of which is incorporated herein by reference.

### TECHNICAL FIELD

The present invention relates to a vehicle seat belt coupling apparatus, and more particularly to a vehicle seat belt coupling apparatus that enables a seat belt to be quickly and easily installed in a vehicle.

### BACKGROUND ART

Seats in a car are usually equipped with seat belts to protect the passengers from the impact of an accident.

A conventional three-point seat belt consists of a retractor mounted on the lower part of the B-pillar of a vehicle, a shoulder anchor mounted on the upper part of the B-pillar of the vehicle, a low anchor anchored to the bodywork on the lower side of the seat on one side of the seat facing the B-pillar, a webbing extending from the retractor and anchored to the low anchor via the shoulder anchor, a tongue plate provided on the webbing, and a buckle anchored to the other side of the seat and engaged with the tongue plate.

If these conventional vehicle seat belts need to be installed on the vehicle or removed from the vehicle for maintenance, a pneumatic tool must be inserted between the seat and the B pillar to couple or separate the tongue plate to the low anchor, but there is a problem that the webbing cannot be attached and detached quickly because the seat and B pillar are narrow.

### TECHNICAL PROBLEM

The present invention is directed to solve the above problems and aims to provide a vehicle seat belt coupling apparatus that enables quick and easy removal of the webbing from the low anchor.

### SOLUTION TO PROBLEM

To achieve the above objectives, a vehicle seat belt coupling apparatus according to the present invention comprises a first tongue plate provided at an end of a webbing, a fixing bracket fixed to the first tongue plate, a low anchor having a second tongue plate that fits into the fixing bracket and is fixed to the body of a vehicle at a lower side of a seat, and a locking element installed inside the fixing bracket to lock or unlock the second tongue plate that fits into the fixing bracket.

Furthermore, the fixing bracket may comprise a front bracket and a rear bracket joined together to form an opening into which the top of the second tongue plate is inserted. In this case, the locking element may be installed on the fixing bracket to lock the second tongue plate inserted into the opening of the fixing bracket when moving forward and release the locking state of the second tongue plate when moving backward upward.

Further, the locking element may comprise a lifting block mounted on the inside of the fixing bracket so as to be positioned above the locking button, a first elastic member providing a downward force to the lifting block so that the lifting block presses the locking button downwardly, and a second elastic member mounted on the rear bracket to press the unlocked locking button forwardly.

On the other hand, the locking element may comprise a support, that is installed on the rear bracket, to restrict the rear movement of the locking button so that the locking button moving forward is not released as the locking button is forced to move backward.

In this case, the lifting block may comprise a main body which is located inside the fixing bracket and presses downwardly on the front end of the locking button, and left and right wings pressed upward by a second tongue plate that is protruding to both sides of the main body and is inserted into the fixing bracket.

Furthermore, a receiving groove may be formed on the lower surface of the main body of the lifting block. In this case, a stumbling block may be formed on the top of the locking button that limits the forward movement of the locking button by deviating from the receiving groove and interfering with the rear of the body of the lifting block when the locking button is forced to move backward.

Further, the second elastic element may be a leaf spring that elastically deforms when pressed against a locking button that is moved backwardly by an external force.

Furthermore, the top of the second tongue plate may be formed with a vertical opening groove into which the main body of the lifting block and the front end of the locking button are vertically inserted. In this case, a horizontal groove may be formed in the lower part of the vertical opening groove into which the rear end of the forwardly moving locking button is inserted.

Furthermore, the rear end of the locking button may be formed to extend along the horizontal groove at an inclined angle on both sides to facilitate entry into the horizontal groove.

### ADVANTAGEOUS EFFECTS OF INVENTION

The vehicle seat belt coupling apparatus according to the present invention, configured as described above, enables easy and simple coupling of the webbing to the low anchor by a simple operation of inserting the fixing bracket fixed on the end of the webbing into the low anchor, and easy and simple separation of the webbing from the low anchor by a simple operation of pressing the locking button to the rear, and also has the effect of ensuring stability since the webbing cannot be separated from the low anchor unless the locking button is pressed.

### BRIEF DESCRIPTION OF DRAWINGS

FIG. 1 is a perspective view of a vehicle seat belt coupling apparatus according to the present invention.

FIG. 2 is an exploded view of a vehicle seat belt coupling apparatus according to the present invention.

FIG. 3 is a rear perspective view illustrating the first tongue plate and fixing bracket of the present invention in combination.

FIG. 4 is a rear exploded perspective view of a fixing bracket and a locking element constituting the present invention.

FIG. 5 is a side cross-sectional view illustrating the locking process of the vehicle seat belt coupling apparatus according to the present invention in sequence.

FIG. 6 is a top view illustrating the locking process of the vehicle seat belt coupling apparatus according to the present invention in sequence.

FIG. 7 is a side cross-sectional view illustrating the unlocking process of a vehicle seat belt coupling apparatus according to the present invention in sequence.

### DESCRIPTION OF REFERENCE NUMERALS

100: 1st tongue plate

200: fixing bracket
201: cover
202: passing groove
210: front bracket
211: matching hook
212: 1st guide hole
213: 3rd guide hole
220: rear bracket
221: matching groove
222: 2nd guide hole
223: fixing end
300: low anchor
310: 2nd tongue plate
311: vertical opening groove
312: horizontal opening groove
400: locking element
410: locking button
411: front
412: rear
413: stumbling block
420: lifting block
421: main body
422: left and right wing
423: forward protrusion
424: receiving groove
425: upper protrusion
430: 1st elastic element
440: 2nd elastic element
450: support
W: webbing

### Detailed Description of Invention

The features and advantages of the present invention will become more apparent from a detailed description of the following preferred embodiments with reference to the accompanying drawings.

In this regard, the terms and words used in this specification and claims should be construed to have a meaning and concept consistent with the technical idea of the invention, based on the principle that the inventor may define the concept of a term as he sees fit to best describe his invention.

Furthermore, the terms and words used in this specification and claims are used to describe particular embodiments only and are not intended to limit the invention.

For example, the singular expression includes the plural unless the context clearly indicates otherwise. Further, the terms “includes,” “comprises,” “consist,” or “have” are intended to designate the presence of the features, numbers, steps, actions, components, parts, or combinations thereof described in the specification and are not to be understood as precluding the possibility of the presence or addition of one or more other features, numbers, steps, actions, components, parts, or combinations thereof.

Also, it will be understood that when an element such as a layer, film, region, or substrate is referred to as being “on” another element, it can be directly on the other element or intervening elements may also be present. Conversely, when an element such as a layer, film, region, or substrate is referred to as being “under” another element, it may be directly under the other element or intervening elements may be present.

Further, as used herein, ordinal terms such as “first,” “second,” and the like may be used to describe various components, but the components are not limited by such terms, and such terms are used only to distinguish one component from another.

Hereinafter, in describing an embodiment of the present invention in detail with reference to the drawings, the same reference numerals are used for the same configuration, and only different parts will be mainly described for clarity.

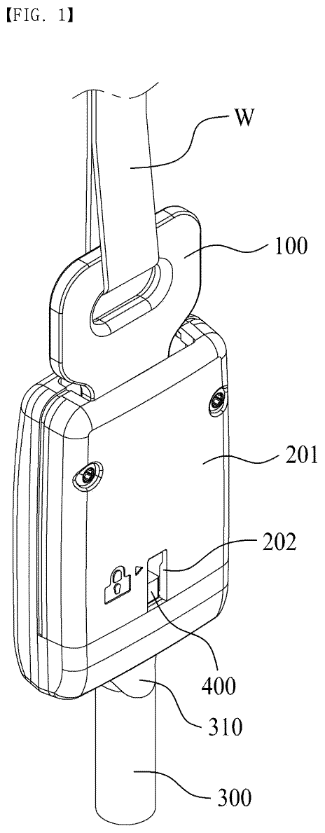

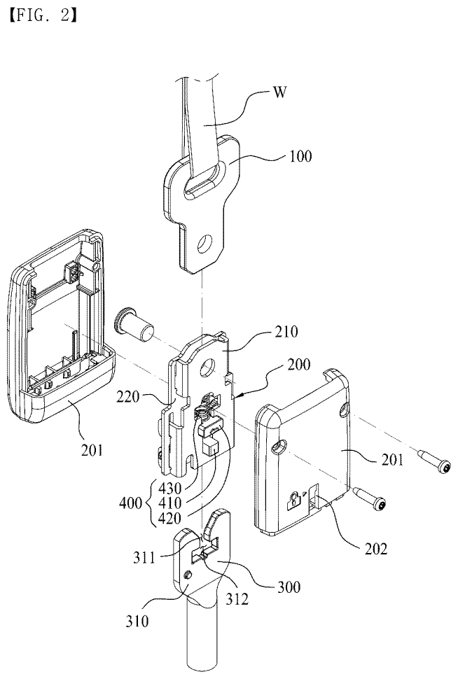

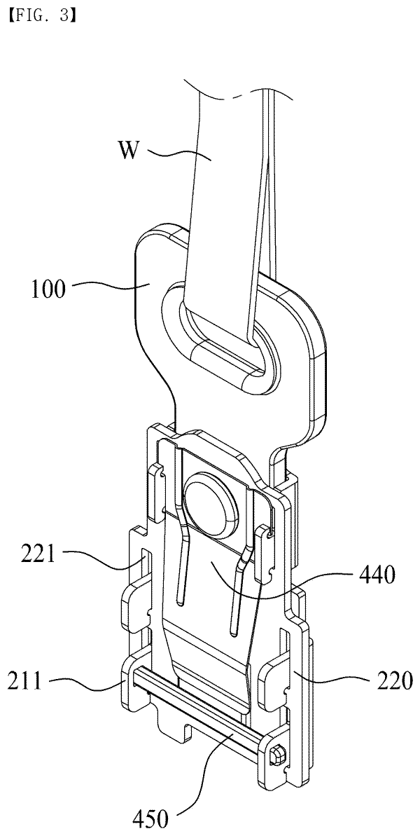

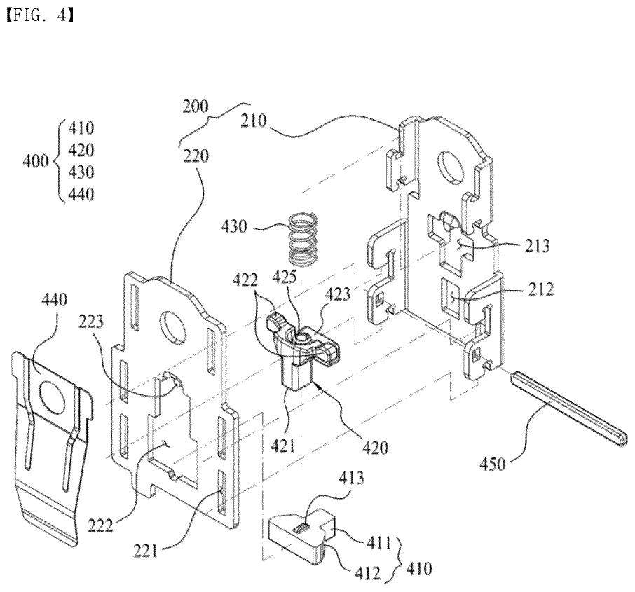

As shown in FIG. 1 to 7, a vehicle seat belt coupling apparatus according to the invention comprises a first tongue plate 100 provided at an end of a webbing W, a fixing bracket 200 fixed to the first tongue plate 100, a low anchor 300 having a second tongue plate 310 that fits into the fixing bracket 200 and is secured to the body of the vehicle at one lower side of the seat, and a locking element 400 installed on the inside of the fixing bracket 200 to lock or unlock the second tongue plate 310 that fits into the fixing bracket 200.

The fixing bracket 200 may comprise a front bracket 210 and a rear bracket 220 that coalesce to form an opening at the bottom into which the top of the second tongue plate 310 is inserted.

In this case, the front bracket 210 and the rear bracket 220 may be formed with a matching hook 211 and a matching groove 221 corresponding to the matching hook 211, respectively.

The fixing bracket 200 is preferably configured to be protected against external impact and the ingress of foreign objects by means of a separate cover 201.

The locking element 400 comprises a locking button 410, and a lifting block 420 installed inside the interior of the fixing bracket 200 so as to be positioned on top of the locking button 410, a first elastic member 430 providing a downward force to the lifting block 420 such that the lifting block 420 presses downwardly on the locking button 410, and a second elastic member 440 installed on the rear bracket 220 to press forwardly on the unlocked locking button 410.

The locking button 410 is movably installed on the inner side of the fixing bracket 200 to move up and down and back and forth, and locks the second tongue plate 310 inserted into the opening of the fixing bracket 200 in the forward movement, and unlocks the second tongue plate 310 in the backward upward movement.

The locking button 410 is pushed upwardly against the second tongue plate 310 inserted into the opening.

In this case, the front bracket 210 may be formed with a first guide hole 212 into which the front 411 of the locking button 410 is inserted to allow the locking button 410 to move stably back and forth and up and down, and the rear bracket 220 may be formed with a second guide hole 222 into which the rear 412 of the locking button 410 is inserted.

On the other hand, a passing groove 202 is formed in the cover 201 through which a front 411 of the locking button passes so that the locking button 410 to be described later can be pressed by an operator.

In this case, the passing groove 202 is formed so that the interior is visible when viewed from the outside of the cover 201, so that the locking button 410 and the lifting block 420 can be checked for operation. This is to allow for easy visual confirmation of the locked and unlocked states including when the locking is not properly engaged.

The lifting block 420 may comprise a main body 421 that is positioned inside the fixing bracket 200 and presses downwardly on the locking button 410, and left and right wings 422 that project bilaterally on top of the main body 421 and are pressed upwardly by a second tongue plate 310 that fits into the fixing bracket 200.

On the other hand, the main body 421 of the lifting block 420 is formed with a forward protrusion 423 to stabilize the elevating motion of the lifting block 420, and the front bracket 210 is preferably vertically formed with a third guide hole 213 into which the forward protrusion 423 of the lifting block 420 is inserted. The third guide hole 213 is formed on the upper part of the first guide hole 212.

The first elastic member 430 may be a compression coil spring with an upper end secured to the fixing bracket 200 and a lower end secured to the upper end of the lifting block 420.

In this case, the top of the lifting block 420 may be formed with an upper protrusion 425 to which the lower end of the first elastic element 430 is fitted and fixed. And the front bracket 210 and the rear bracket 220 may each have a fixing end 223 on which the upper end of the first elastic member 430 is fixed.

The second elastic element 440 is installed at the rear of the rear bracket 220 to face the second guide hole 222 and is elastically deformed to the rear by being pressed against the rear 412 of the locking button 410, which is forced to move to the rear by the operator's pressing action. At this time, the locking button 410 is in an unlocked state of the second tongue plate 310 and is continuously subjected to a forward movement force by the second elastic element 440.

On the other hand, at the top of the second tongue plate 310, a vertical opening groove 311 is formed in which the main body 421 of the lifting block 420 and the front 411 of the locking button 410 are vertically fitted.

And at the lower end of the vertical opening groove 311, a horizontal opening groove 312 is formed in which the rear 412 of the forwardly moving locking button 410 is inserted. In this case, the rear 412 of the locking button 410 is preferably formed to extend inclinedly on both sides along the horizontal opening groove 312 to facilitate entry into the horizontal opening groove 312.

In one aspect, the second elastic member 440 may be a leaf spring with an upper end secured to a rear surface of the rear bracket 220.

Further, a support 450 may be installed on the rear bracket 220.

The support 450 is a horizontal bar across the lower portion of the second guide hole 222, which limits the backward movement of the locking button 410 so that a forwardly moved locking button 410 is not forced to move backward and unlock the locking state. Thus, the locking state can be stably maintained.

While this embodiment illustrates the support 450 being secured by fitting both ends into the matching hook 211 formed on the front bracket 210 to prevent the mated front bracket 210 and rear bracket 220 from separating, it need not be limited to this example and may be configured to be secured directly to the rear of the rear bracket 220.

Preferably, a stumbling block 413 is formed on the top of the locking button 410, and a receiving groove 424 is formed on the underside of the main body 421 of the lifting block 420 to receive the stumbling block 413.

In this case, the stumbling block 413 is accommodated in the receiving groove 424 in the locking state, and then, when the locking button 410 is forcibly moved backward for unlocking, the movement of the locking button 410 is restricted by being separated from the receiving groove 424 and interfering with the rear surface of the body 421 of the lifting block 420. Accordingly, the unlocking state may be stably maintained.

Using the vehicle seat belt coupling apparatus of the present invention configured as described above, it is possible to quickly and easily attach and detach the webbing W from the low anchor 300 fixed to the vehicle body below one side of the seat.

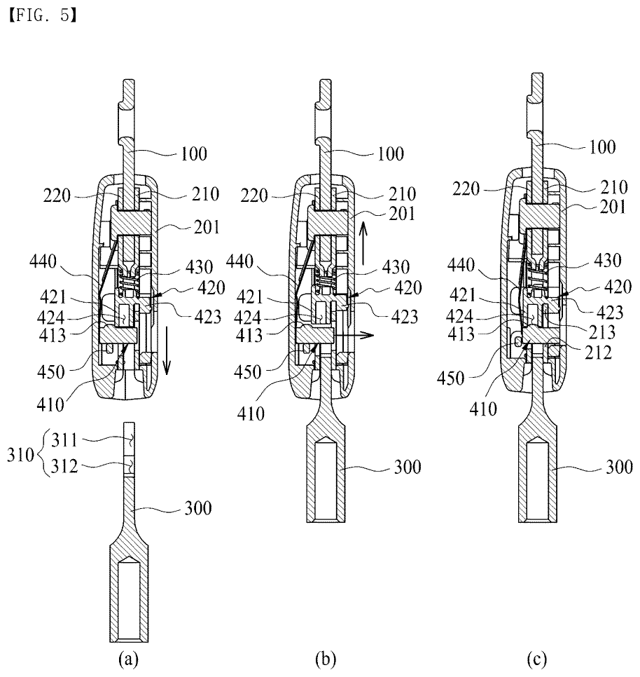

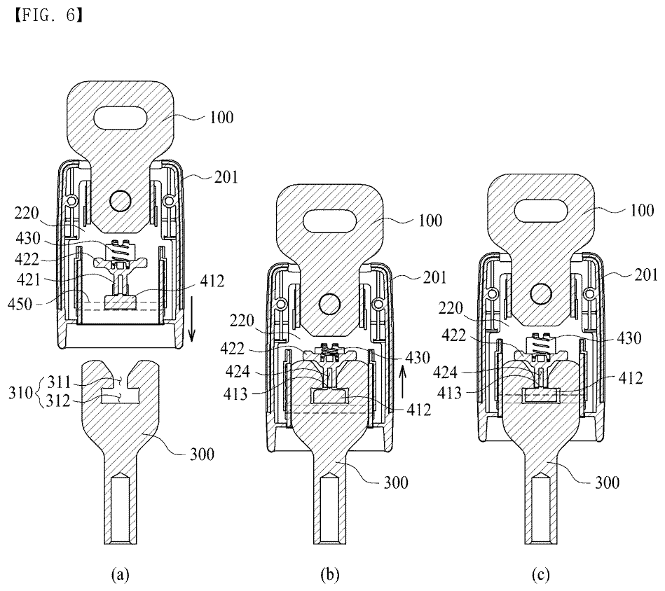

As shown in FIGS. 5A and 6A, when an operator wants to separate the webbing W from the low anchor 300, the fixing bracket 200 is moved downward using the cover 201 and the upper portion of the low anchor 300 is inserted into the opening portion of the fixing bracket 200. As shown in FIGS. 5B and 6B, the front 411 of the locking button 410 sequentially passes through the vertical opening groove 311 and the horizontal opening groove 312 of the low anchor 300, and at the same time, the main body 421 of the lifting block 420 is fitted into the vertical opening groove 311 of the low anchor 300, and the left and right wing 422 of the lifting block 420 are in contact with the upper end of the second tongue plate 310. Accordingly, the lifting block 420 is raised while compressing the first elastic element 430, and at the same time, the front 411 of the locking button 410 is in contact with the horizontal opening groove 312, and the locking button 410 is also raised.

As shown in FIGS. 5C and 6C, when the lifting block 420 is raised, the interference of the stumbling block 413 of the locking button 410 with the lifting block 420 is released, causing the locking button 410 to be moved forward by the pressing force of the second elastic element 440, In this process, the stumbling block 413 of the locking button 410 is received in the receiving groove 424 formed on the lower surface of the main body 421 of the lifting block 420, and the rear 412 of the locking button 410 enters the horizontal opening groove 312.

When the rear 412 of the locking button 410 enters the horizontal opening groove 312, the locking bracket 200, the second tongue plate 310, and the low anchor 300 are engaged and locked, and when the operator stops the downward movement of the locking bracket 200, the first elastic element 430 in the compressed state is stretched and restored, causing the fixing bracket 200 to rise, and in this process, the support 450 is positioned at the rear of the locking button 410.

Thus, the backward movement of the locking button 410 is limited while the locking state remains stable.

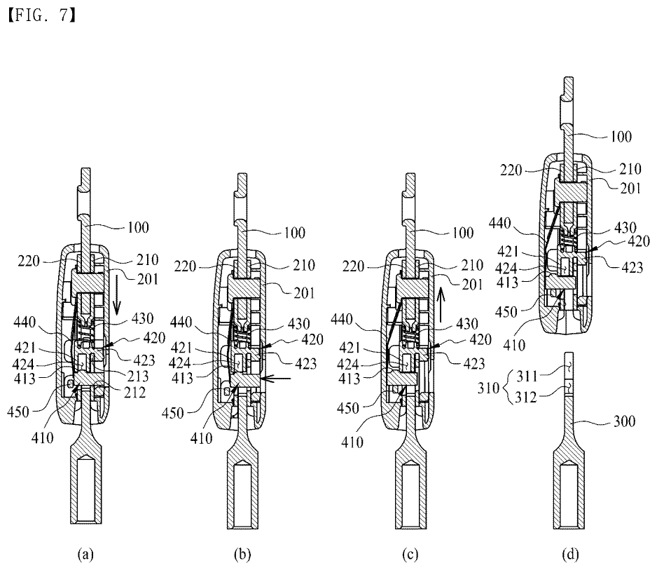

As shown in FIG. 7a, when the operator wishes to engage the webbing W on the low anchor 300, the cover 201 is utilized to move the fixing bracket 200 downwardly, as shown in FIG. 7b, The lifting block 420 is pushed up against the low anchor 300 by compressing the first elastic element 430, and at the same time, the locking button 410 is pushed up as the rear 412 of the locking button 410 contacts the horizontal opening groove 312.

In this process, the locking button 410 and the lifting block 420 are spaced apart, causing the stumbling block 413 of the locking button 410 to be disengaged from the receiving groove 424 of the lifting block 420. Furthermore, as the locking button 410 is positioned on the upper side of the support 450, the rearward movement restriction by on the support 450 is released.

At this time, the operator presses the front 411 of the locking button 410 to force the locking button 410 to move rearwardly, as shown in FIG. 7C, As the rear 412 of the locking button 410 is moved away from the horizontal opening groove 312 of the low anchor 300, the front 411 of the locking button 410 enters the horizontal opening groove 312, and the locking state is released as the fixing bracket 200 and the second tongue plate 310 are disengaged.

In this process, as the second elastic element 440 is elastically deformed, the rear 412 of the locking button 410 is pressed forward. In this state, when the operator stops moving the lower part of the fixing bracket 200, the first elastic element 430 in the compressed state is extended and restored, the lifting block 420 descends to closely press the upper end of the locking button 410, and the stumbling block 413 is supported by the main body 421 of the lowered lifting block 420, and the support 450 supports the rear 412 of the locking button 410 from below.

Accordingly, the locking button 410 maintains a stable horizontal state while preventing forward movement, and the unlocking state remains stable.

In this state, when the operator moves the fixing bracket 200 upwardly using the cover 201, the front 411 of the locking button 410 passes through the horizontal opening groove 312 and the vertical opening groove 311 in turn, causing the fixing bracket 200 to separate from the second tongue plate 310 and the low anchor 300, as shown in FIG. 7D.

As described above, the vehicle seat belt coupling apparatus according to the present invention can easily and conveniently couple the webbing W to the low anchor 300 only by a simple operation of inserting the fixing bracket 200 fixed to the end of the webbing W into the low anchor 300, and not only can the webbing W be easily and easily separated from the low anchor 300 by a simple operation of pressing the locking button 410 backward, but also stability is guaranteed because the webbing W is not separated from the low anchor 300 unless the locking button 410 is pressed.

While the foregoing has shown and described preferred embodiments of the invention with reference to the drawings, various modifications and changes may be made without departing from the spirit or field of the invention as established by the following claims, which are also intended to be included within the scope of the invention.

1. A vehicle seat belt coupling apparatus comprise:
a first tongue plate provided at the end of a webbing;
a fixing bracket secured to the first tongue plate above;
a low anchor having a second tongue plate that fits into the fixing bracket and is secured to the bodywork on one lower side of the seat; and
a locking element installed on the inside of the fixing bracket for locking or unlocking a second tongue plate fitted to the fixing bracket.

2. The vehicle seat belt coupling apparatus of claim 1,
wherein the fixing bracket comprises a front bracket and a rear bracket joined together to form an opening into which the top of the second tongue plate is inserted,
wherein the locking element is movably installed on the fixing bracket to lock the second tongue plate inserted into the opening of the fixing bracket in the forward movement, and is provided with a locking button to unlock the second tongue plate in the backward upward movement.

3. The vehicle seat belt coupling apparatus of claim 2,
wherein the locking element comprises;
a lifting block installed inside the fixing bracket so that it sits on top of the locking button;
a first elastic element providing a downward force on the lifting block 420 to cause the lifting block to press downwardly on the locking button; and
a second elastic element installed on the rear bracket to press forward the locking button that has been unlocked.

4. The vehicle seat belt coupling apparatus of claim 2,
wherein the locking element is installed on the rear bracket and has a support for restricting the rearward movement of the locking button so that the locking button moving forward is not released as the locking button is forced to move backward.

5. The vehicle seat belt coupling apparatus of claim 3,
wherein the lifting block comprises;
a main body positioned inside the fixing bracket and pressing downwardly on the front end of the locking button; and
left and right wings pressed upward by a second tongue plate that is protruding to both sides of the main body and is inserted into the fixing bracket.

6. The vehicle seat belt coupling apparatus of claim 5,
wherein the vehicle seat belt coupling apparatus comprises;
a receiving groove is formed on the lower surface of the main body of the lifting block, and
a stumbling block is formed on the top of the locking button to restrict the forward movement of the locking button by interfering with the rear of the main body of the lifting block when the locking button is forced to move backward by being separated from the receiving groove.

7. The vehicle seat belt coupling apparatus of claim 3,
wherein the second elastic element comprises a leaf spring that is elastically deformed when pressed against the locking button that is moved backwardly by an external force.

8. The vehicle seat belt coupling apparatus of claim 6,
wherein the vehicle seat belt coupling apparatus comprises;
a vertical opening groove is formed at the top of the second tongue plate into which the main body of the lifting block and the front end of the locking button are vertically fitted,
a horizontal opening groove is formed under the vertical opening groove in which the rear of the locking button moving forward is fitted.

9. The vehicle seat belt coupling apparatus of claim 8,
wherein the rear of the locking button is formed to extend inclinedly on both sides along the horizontal opening groove to facilitate entry into the horizontal opening groove.
